(19) United States
(12) Patent Application Publication
(10) Pub. No.: US 2024/0109168 A1
(43) Pub. Date: Apr. 4, 2024

(54) SOCKET DRIVER ASSEMBLY FOR TIGHT SPACES

(71) Applicant: Dale Palmgren, Villa Ridge, MO (US)

(72) Inventor: Dale Palmgren, Villa Ridge, MO (US)

(21) Appl. No.: 17/956,743

(22) Filed: Sep. 29, 2022

(51) Int. Cl. B25B 21/00

(52) U.S. Cl. CPC B25B 21/002; B25B 21/02

(57) ABSTRACT

A socket driver assembly for rotating a socket to unfasten or fasten a fastener fitted in the socket is provided. The socket driver assembly includes a housing, a first gear, and a socket gear. The first gear is rotatable about a first axis. The socket gear is configured to receive and engage the socket. The socket gear is rotatable about a second axis that is perpendicular to the first axis. The housing houses the first gear and the socket gear. The first gear engages the socket gear such that rotation of the first gear about the first axis causes rotation of the socket gear and socket about the second axis.

### FIELD

This application relates to a socket driver assembly and apparatus having the socket driver assembly that is design to operate quickly in tight spaces.

### BACKGROUND

It is generally known that there are many occasions that people have problems getting a socket wrench or end wrench into a tight space and have enough room to move the wrench to tighten or loosen a nut or bolt. It is very frustrating when the wrench will only move a quarter of a turn or less before having to reset only to move the nut or bolt another quarter turn or less. This takes a great deal of time to tighten or loosen a nut or bolt.

Socket driver assemblies may benefit from improvements.

### SUMMARY

In one aspect of the present invention, a socket driver assembly for rotating a socket to unfasten or fasten a fastener fitted in the socket is provided. The socket driver assembly includes a housing, a first gear, and a socket gear. The first gear is rotatable about a first axis. The socket gear is configured to receive and engage the socket. The socket gear is rotatable about a second axis that is perpendicular to the first axis. The housing houses the first gear and the socket gear. The first gear engages the socket gear such that rotation of the first gear about the first axis causes rotation of the socket gear and socket about the second axis.

In another aspect of the present invention, an apparatus is provided that includes a socket, a socket driver assembly, a driver, and a driver bit. The socket driver assembly includes a housing, a first gear, and a socket gear. The first gear is rotatable about a first axis. The socket gear is in operative engagement with the socket. The socket gear is rotatable about a second axis that is perpendicular to the first axis. The housing houses the first gear and the socket gear. The first gear engages the socket gear such that rotation of the first gear about the first axis causes rotation of the socket gear and the socket about the second axis. The driver bit is removably coupled to the driver and the first gear. The driver is operative to rotate the driver bit. Rotation of the driver bit causes rotation of the first gear about the first axis.

Other aspects of the disclosed invention will become apparent from the following detailed description, the accompanying drawings and the appended claims.

### BRIEF DESCRIPTION OF THE DRAWINGS

FIG. 1 is a bottom and rear perspective view of the socket driver assembly according to an embodiment of the present invention.

FIG. 2 is a view similar to FIG. 1 but with the bottom cover exploded from the top cover and with hidden lines for illustrative purposes.

FIG. 3 is a top and rear perspective view of the socket driver assembly of FIG. 1 and with hidden lines for illustrative purposes.

FIG. 4 is an apparatus that includes the socket driver assembly of FIG. 1 being used to unfasten a bolt.

FIG. 5 is a top perspective view of the socket driver assembly of FIG. 3 that is rotated one hundred and eighty degrees about its longitudinal axis.

FIG. 6 is a perspective view of the socket of the apparatus of FIG. 4.

FIG. 7 is a bottom view of the socket driver assembly of FIG. 1 but with the bottom cover removed for illustrative purposes and the second drive socket portion of the socket received in the socket gear.

FIG. 8 is a perspective view of the socket adapter of the present invention and related elements in phantom lines.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

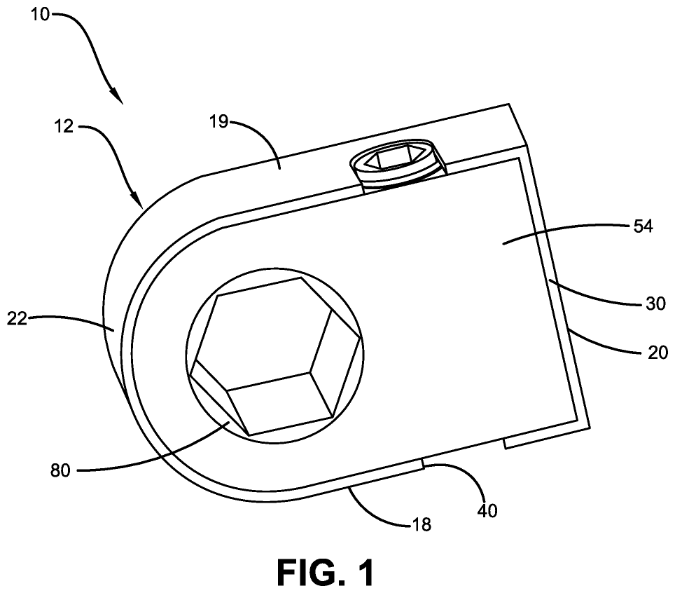

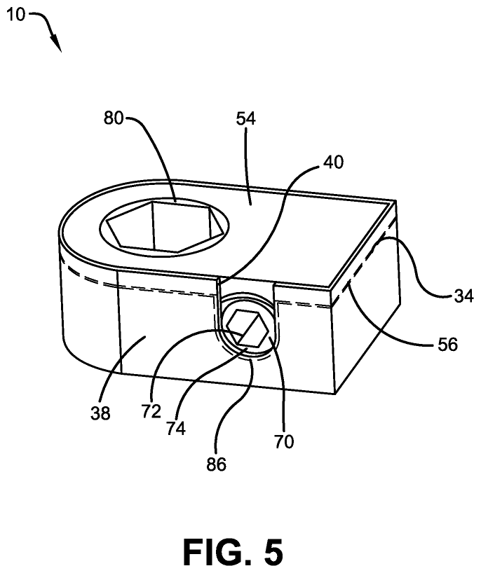

Throughout the present description, the terms “upper”, “lower”, “top”, “bottom”, “left”, “right”, “front”, “forward”, “rear”, and “rearward” shall define directions or orientations with respect to the socket driver assembly as illustrated in FIG. 1, which shows a bottom view. It will be understood that the spatially relative terms “upper”, “lower”, “top”, “bottom”, “left”, “right”, “front”, “forward”, “rear”, and “rearward” are intended to encompass different orientations of the hospital gown in use or operation in addition to the orientation depicted in the figures. For example, if the socket driver assembly in FIGS. 1-4 is turned over as illustrated in FIG. 5, elements described as “upper” elements or features would then be “lower” elements or features.

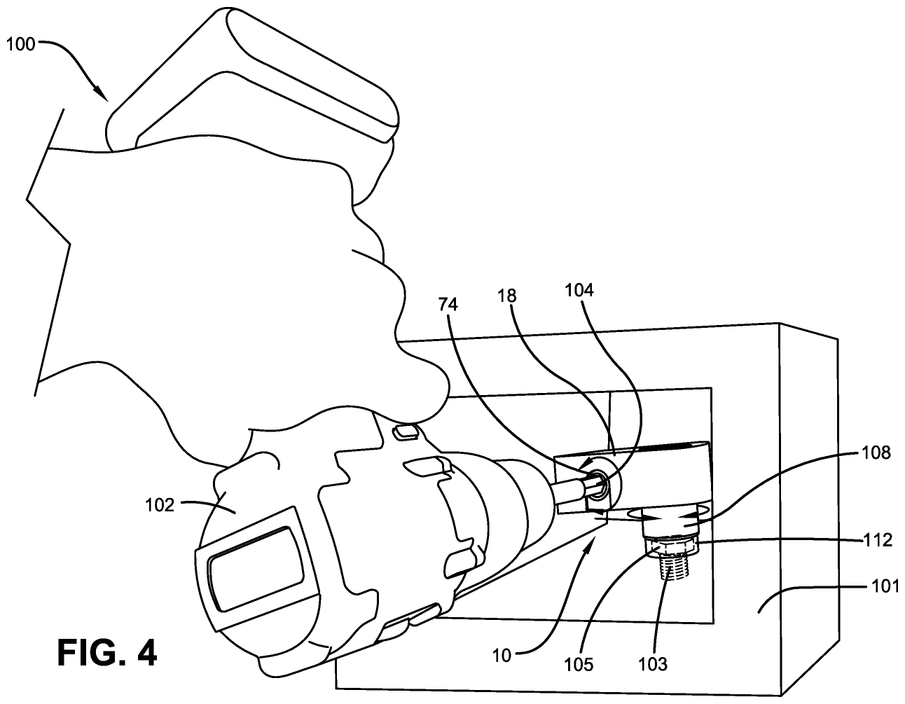

As illustrated in FIG. 4, the present invention solves the above-mentioned problems by providing a socket driver assembly 10 that receives a standard ¼ inch drive bit 104 that is removably attached to an impact drill 102 or other type of drill. The drive bit 104 would fit into a hole in the socket driver assembly 10 and engage it. When the impact drill 102 is turned on to rotate the drive bit 104, the driver assembly 10 rotates a socket 108 fitted over a bolt 103 or other fastener using a gear system. This configuration could easily fit into small places and tighten or loosen nuts or bolts that typical ratchets and wrenches have a difficult time with.

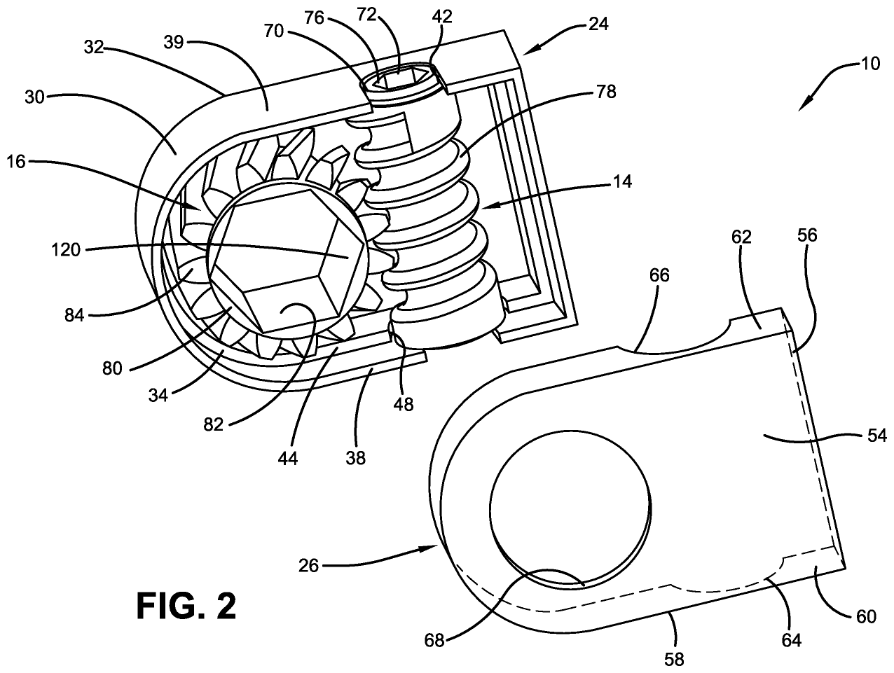

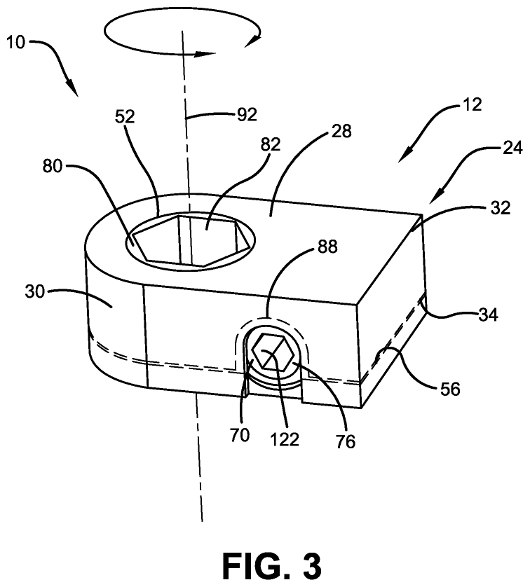

Referring to FIGS. 1 and 2, the socket driver assembly 10 comprises a housing 12, a worm gear 14, and a socket gear 16. These components of the socket driver assembly 10 may be made of hard plastic or other suitable rigid material. The housing 12 houses the worm gear 14 and the socket gear 16. The housing 12 is generally u-shaped as view from the top and includes opposite parallel front and rear longitudinal sides 18, 19, a straight lateral side 20, and a convexly curved lateral side 22 opposite the straight lateral side 20. The housing 12 includes a top cover 24 and a bottom cover 26 that are press fit or otherwise connected together in a clam shaped arrangement. As seen in FIGS. 2 and 3, the top cover 24 incudes a top wall 28 (FIG. 3) and an outer side wall 30 that extends downwardly from the peripheral end 32 of the top wall 28 and extends around the perimeter of the top wall 28. The top cover 24 also includes an inner side wall 34 that is positioned inwardly adjacent to the outer side wall 30. The inner side wall 34 extends downwardly from the top wall 28 a shorter distance than the outer side wall 30.

The top wall 28 extends transverse to the outer and inner side walls 30, 34. The outer side wall 30 has parallel front and rear longitudinal sides 38, 39 (FIGS. 2 and 5). The front side 38 has an inverted u-shaped notch 40 (FIG. 5) formed therein and the rear side 39 has an inverted u-shaped notch 42 (FIG. 2) formed therein. The notches 40, 42 are located opposite each other. Likewise, the inner side wall 34 has parallel front and rear longitudinal sides 44, 46 (FIGS. 2 and 7). The front side 44 has an inverted u-shaped notch 48 formed therein and the rear side 46 has an inverted u-shaped notch 50 (FIG. 7) formed therein. The notches 48, 50 are located opposite each other. The top wall 28 also includes a top opening 52 (FIG. 3). As illustrated in FIG. 2, the bottom cover 26 includes a bottom wall 54 and a side wall 56. The side wall 56 extends upwardly from the peripheral end 58 of the bottom wall 54 and extends around the perimeter of the bottom wall 54. The bottom wall 54 extends transverse to the side wall 56. The side wall 56 has parallel front and rear longitudinal sides 60, 62. The front side 60 has a u-shaped notch 64 formed therein and the rear side 62 has a u-shaped notch 66 formed therein. The notches 64, 66 are located opposite each other. The bottom wall 54 also includes a bottom opening 68.

Referring to FIGS. 2 and 5, the worm gear 14 includes a shaft 70, which has a hexagonally shaped bore 72 extending through front and rear axial ends 74, 76 of the shaft 70. The worm gear 14 includes worm gear teeth 78 which are formed as a continuous coarse screw thread that revolves around the shaft 70. As depicted in FIGS. 2 and 7, the socket gear 16 has as a first drive socket portion 80 that defines a hex shaped bore 82 and socket gear teeth 84 extending radially from the first drive socket portion 80. The first drive socket portion 80 includes an inner side 120 (FIG. 2). The worm gear 14 and the socket gear 16 fit securely in the housing with the worm gear teeth 78 in meshing engagement with the socket gear teeth 84. In particular, the worm gear 14 is rotatably received in the inverted u-shaped notches 48, 50 of the inner side wall 34, the inverted u-shaped notches 40, 42 of the outer side wall 38, and the u-shaped notches 64, 66 of the side wall 56 such that the front and rear axial ends 74, 76 of the hollow shaft 70 of the worm gear 14 are exposed through the housing 12. The socket gear 16 is positioned in the top cover 24 such that the hex shaped bore 82 is aligned with the top opening 52. The inner side wall 34 surrounds the socket gear 16 to help to prevent the worm gear 14 from laterally disengaging from the socket gear 16. The bottom cover 26 is secured to the top cover 24 such that the side wall 56 of the bottom cover 26 fits inside the top cover 24 with the top of the side wall 56 of the bottom cover 26 abutting against the bottom of the inner side wall 34 of the top cover 24 as illustrated in FIGS. 3 and 5. The bottom cover 26 may be secure to the top cover 24 by any suitable way such as, for example, by fasteners or adhesive. The socket gear 16 is positioned in the bottom cover 26 such that the hex shaped bore 82 is aligned with the bottom opening 68 as shown in FIGS. 1 and 5. Reinforcing structure such as bearings may be provided around the ends of the openings 52, 68 to help support the socket gear 16 as it rotates.

The u-shaped notches 64, 66 in the side wall 56 of the bottom cover 26 are aligned and positioned under the inverted u-shaped notches 40, 42 of the inner side wall 34 of the top cover 24 to define front and rear lateral openings such that the ends of the side wall 56 and inner side wall 34 defining each of the lateral openings act as front and rear bearings 86, 88 that support the worm gear 14 and also enable the worm gear 14 to rotate about its axis 90 (FIG. 7). The bottom wall 54 is generally flushed with the bottom of the outer side wall 30 of the top cover 24 and is parallel with the top wall 28 as illustrated in FIG. 1. The worm gear 14 rotates about the axis 90 that is generally parallel with the top and bottom walls 28, 54. The socket gear 16 rotates about axis 92 (FIGS. 3 and 7) that is perpendicular to the axis 90 of rotation of the worm gear 14 and perpendicular to the top and bottom walls 28, 54. So, when the socket driver assembly 10 is positioned flat on a level ground, the axis 92 that the socket gear 16 rotates about is vertical and the axis 90 that the worm gear rotates about is horizontal. The distance between the opposite top and bottom walls 28, 54 of the housing 12 along the axis 92 is less than the distance between the opposite longitudinal sides 18, 19 of the housing along the axis 90. This relatively thin socket driver assembly 10 enables the socket driver assembly 10 to fit in small areas.

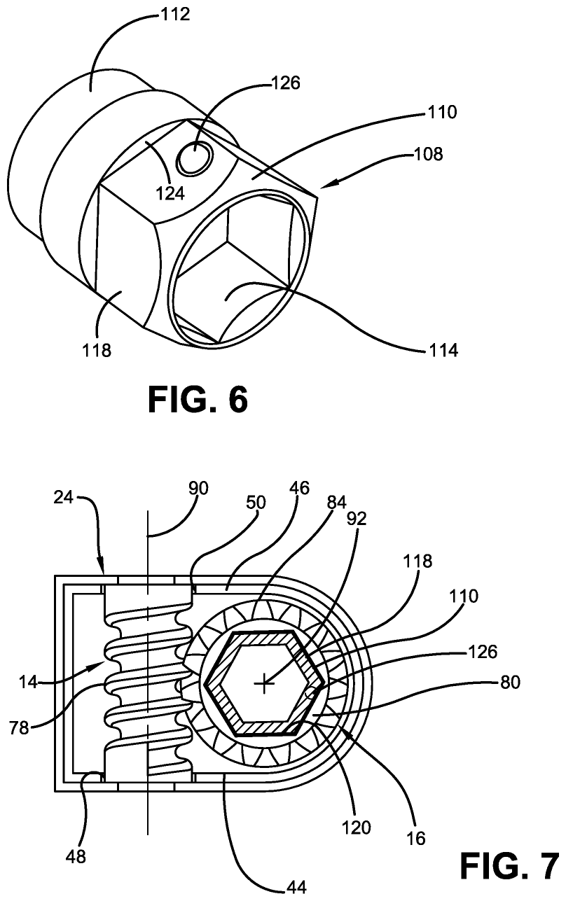

FIG. 4 shows an apparatus 100 that illustrates the operation of the socket driver assembly 10 to unfasten a bolt 103 threadily connected into a structure 101. The apparatus 100 comprises the socket driver assembly 10, the impact drill 102, the drive bit 104, and the pass through socket 108. The pass through socket 108 has a hex shaped second drive socket portion 110 (FIGS. 6 and 7) on one axial end and a larger sized hex socket 112 on the other end. The second drive socket portion 110 may have a hex shape opening 114 or be solid. The second drive socket potion 110 includes an outer side 118 (FIG. 6). The drive bit 104 may be a standard ¼ inch impact bit that is hexagonally shaped and removably attached to an impact drill 102. The drive bit 104 is securely inserted into the bore 72 of the shaft 70 of the worm gear 14 at the front axial end 74 (shown in FIG. 4) or the rear axial end 76 and engages an inner side 122 (FIG. 3) of the shaft 70 defining the bore 72. The second drive socket portion 110 of the pass through socket 108 is received in the bore 82 defined by the first drive socket portion 80 as illustrated in FIG. 7. Since the bore 82 is aligned with the top and bottom openings 52, 68 of the housing 12, the first drive socket portion 80 is accessible to receive and engage the second drive socket portion 110 through the top or bottom openings 52, 68 of the housing 12. This enables the drive socket assembly 10 to be flipped over (FIG. 5) with the top opening 52 facing the head 105 of a bolt 103 or other fastener to fasten or unfasten the bolt 103.

The outer side 118 of the second drive socket portion 110 engages the inner side 120 of the first drive socket portion 80 as seen in FIG. 7, such that rotation of the socket gear 16 rotates the first and second drive socket portions 80, 110 and hex socket 112 about the axis 92. A rim 124 (FIG. 6) of the hex socket 112 engages the first drive socket portion 80 of the socket gear 16 and acts as a stop to prevent the second drive socket portion 110 from passing through the side of the first drive socket portion 80 opposite the side of the first drive socket portion 80 adjacent the rim 124. A ball retainer 126 (FIGS. 6 and 7) is provided on the second drive socket portion 110 to help retain the second drive socket portion 110 to the first drive socket portion 80 yet enable the second drive socket portion 110 to be removed from the first drive socket portion 80 by a user grasping the hex socket 112 and pulling away from first drive socket portion 80. The hex socket 112 is fitted onto the head 105 of the threaded bolt 103 and engages the head 105 of the bolt 103 as shown in FIG. 4.

In operation, the impact drill 102 is turned on to rotate the drive bit 104 inserted in the bore 72 clockwise about the axis 90. Rotation of the drive bit 104 in turn rotates the worm gear 14 about the axis 90. Rotation of the worm gear 14 rotates the socket gear 16 about the axis 92. Rotation of the socket gear 16 in turn rotates the first and second drive socket portions 80, 110 and hex socket 112 about the axis 92, which rotates the head 105 of the bolt 103 counterclockwise to unfasten it from the structure 101. As seen in FIGS. 3 and 4, the small height or thickness of the socket driver assembly 10 between the top and bottom walls enables the socket driver assembly to be placed over a bolt 103 in small tight spaces. The configuration of the socket driver assembly 10 also enables the use of the impact drill 102 or other drill to operate the socket driver assembly 10 from the easier accessible lateral side of the socket driver assembly to allow the user to unfasten the bolt 103 quickly without much effort. To tighten the bolt 103, the impact drill 102 may be set to rotate the drive bit 104 counterclockwise to rotate the socket gear 16 and socket 108 clockwise. Because there is no need for a ratchet or wrench to move from side to side on the nut or bolt, the socket driver assembly 10 can easily and conveniently be reached and operated in areas that a ratchet or wrench would have a very difficult time operating in. Also, the socket driver assembly 10 is designed to be used with standard tools such as the driver bit, sockets and the driver.

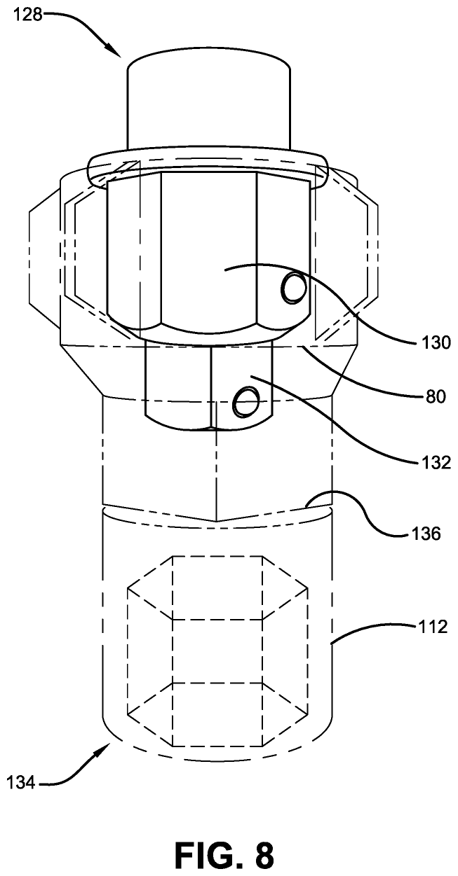

Optionally, as illustrated in FIG. 8, a socket adapter 128 may be provided that has a hex shaped socket adapter driver portion 130 at one axial end that is for insertion and engagement into the first drive socket portion 80 of the socket gear 16 and a square shaped socket adapter driver portion 132 at the other axial end for insertion and engagement into a square shaped third drive socket portion 136 of a socket 134 that has a hex socket 112. Other socket adapters may be included with different shaped socket adapter driver portions to enable the installation of sockets that have other shapes of drive socket portions, or the same hex shape if the socket adapter is to be used as an extension. The pass through socket 108 and the socket adapter 128 may be made of chrome vanadium steel.

Although various embodiments of the disclosed socket driver assembly and apparatus having the socket driver assembly have been shown and described, modifications may occur to those skilled in the art upon reading the specification. The present application includes such modifications and is limited only by the scope of the claims.

What is claimed is:

1. A socket driver assembly for rotating a socket to unfasten or fasten a fastener fitted in the socket comprising:
a housing;
a first gear, wherein the first gear is rotatable about a first axis;
a socket gear, wherein the socket gear is configured to receive and engage the socket, wherein the socket gear is rotatable about a second axis that is perpendicular to the first axis, wherein the housing houses the first gear and the socket gear, wherein the first gear engages the socket gear such that rotation of the first gear about the first axis causes rotation of the socket gear and the socket about the second axis.

2. The socket driver assembly of claim 1, wherein the first gear is a worm gear.

3. The socket driver assembly of claim 2, wherein the worm gear comprises a shaft, wherein the shaft has a first opening extending through a first axial end, wherein the first opening is exposed through the housing, wherein the first axial end is configured to receive and engage a drive bit through the first opening, wherein rotation of the drive bit causes rotation of the worm gear about the first axis.

4. The socket driver assembly of claim 3, wherein the shaft has a second opening extending through a second axial end opposite the first axial end, wherein the second opening is exposed through the housing, wherein the second axial end is configured to receive and engage a drive bit through the second opening.

5. The socket driver assembly of claim 4, wherein the housing includes first side having a first opening and a second side having a second opening, wherein the socket gear includes drive socket portion, wherein the drive socket portion is configured to receive and engage the socket,
wherein the drive socket portion is accessible through the first and second openings of the housing to receive and engage the socket.

6. The socket driver assembly of claim 1, wherein the housing comprises a first cover and a second cover, wherein the first and second cover are fastened to each other in a clam shell arrangement.

7. The socket drive assembly of claim 6, wherein the first cover comprises a first wall, a second wall, and a third wall, wherein the first wall extends transverse to the second wall and the third wall, wherein the second cover comprises a fourth wall and a fifth wall, wherein the fourth wall extends transverse to the fifth wall, wherein the fifth wall is positioned inside the second wall and abuts the third wall.

8. The socket driver assembly of claim 1, wherein the housing includes a first side having a first opening and a second side having a second opening, wherein the socket gear includes a drive socket portion, wherein the drive socket portion is configured to receive and engage the socket, wherein the drive socket portion is accessible through the first and second openings of the housing to receive and engage the socket.

9. The socket driver assembly of claim 1, wherein the distance of the housing between opposite ends along the second axis is less than the distance of the housing between opposite ends along the first axis.

10. An apparatus comprising:
a socket;
a socket driver assembly comprising:
a housing;
a first gear, wherein the first gear is rotatable about a first axis; and
a socket gear, wherein the socket gear is in operative engagement with the socket, wherein
the socket gear is rotatable about a second axis that is perpendicular to the first axis, wherein
the housing houses the first gear and the socket gear, wherein the first gear engages the socket gear such that rotation of the first gear about the first axis causes rotation of the socket gear and the socket about the second axis;
a driver; and
a driver bit, wherein the driver bit is removably coupled to the driver and the first gear, wherein
the driver is operative to rotate the driver bit, wherein rotation of the driver bit causes rotation of the first gear about the first axis.

11. The apparatus of claim 10, wherein the first gear is a worm gear.

12. The apparatus of claim 11, wherein the worm gear comprises a shaft, wherein the shaft has a first opening extending through a first axial end, wherein the first opening is exposed through the housing, wherein the first axial end receives and engages the drive bit through the first opening, wherein rotation of the drive bit causes rotation of the worm gear about the first axis.

13. The apparatus of claim 12, wherein the shaft has a second opening extending through a second axial end opposite the first axial end, wherein the second opening is exposed through the housing, wherein the second axial end is configured to receive and engage the drive bit through the second opening.

14. The apparatus of claim 13, wherein the housing includes a first side having a first opening and a second side having a second opening, wherein the socket gear includes a drive socket portion, wherein the drive socket portion receives and engages the socket, wherein the drive socket portion is accessible through the first and second openings of the housing to receive and engage the socket.

15. The apparatus of claim 10, wherein the housing comprises a first cover and a second cover, wherein the first and second cover are fastened to each other in a clam shell arrangement.

16. The apparatus of claim 15, wherein the first cover comprises a first wall, a second wall, and a third wall, wherein the first wall extends transverse to the second wall and the third wall, wherein the second cover comprises a fourth wall and a fifth wall, wherein the fourth wall extends transverse to the fifth wall, wherein the fifth wall is positioned inside the second wall and abuts the third wall.

17. The apparatus of claim 10, wherein the distance of the housing between opposite ends along the second axis is less than the distance of the housing between opposite ends along the first axis.

18. The apparatus of claim 10, wherein the housing includes first side having a first opening and a second side having a second opening, wherein the socket gear includes a drive socket portion, wherein the drive socket portion is configured to receive and engage the socket, wherein the drive socket portion is accessible through the first and second openings of the housing to receive and engage the socket.

19. The apparatus of claim 10 wherein the driver is an impact driver.

20. The apparatus of claim 10, further comprising a socket adapter, wherein the socket adapter is in operative engagement with the socket and the socket gear such that rotation of the first gear about the first axis causes rotation of the socket gear and the socket adapter about the second axis, wherein rotation of the socket adapter cause rotation of the socket about the second axis.
